(19) United States
(12) Patent Application Publication
(10) Pub. No.: US 2009/0180843 A1
(43) Pub. Date: Jul. 16, 2009

(54) KITCHEN COUNTER ISLAND RISER

(76) Inventors: Kathleen Jackson, Spanaway, WA (US); Ken Jackson, Spanaway, WA (US)

Correspondence Address: R REAMS GOODLOE, JR. & R. REAMS GOODLOE, P.S., 24722 104TH. AVENUE S.E., SUITE 102, KENT, WA, 98030-5322, US

(21) Appl. No.: 12/173,173

(22) Filed: Jul. 15, 2008

Related U.S. Application Data
(60) Provisional application No. 60/950,586, filed on Jul. 18, 2007.

(51) Int. Cl. E04G 21/14; B66B 7/00; B66B 9/02

(52) U.S. Cl. 414/12; 414/10; 187/414; 187/269

(57) ABSTRACT

A storage apparatus and system, especially for kitchens. The apparatus includes a stationary counter portion, a moveable island riser, a lift assembly, and a guide assembly including vertically mounted guide shafts that support guide bearings situated in a housing mounted to the moveable island riser. Electronic sensors protect against operation of the lift assembly when interfering objects are sensed, and then lift assembly operation is interrupted. The moveable island riser provides cabinet space or shelving and may be provided with electrical outlets for use with common kitchen appliances.

### RELATED PATENT APPLICATIONS

This invention claims priority from U.S. Provisional Patent Application Ser. No. 60/950,586 filed on Jul. 18, 2007, entitled KITCHEN COUNTER ISLAND RISER, the disclosure of which is incorporated herein in its entirety, including the specification, drawing, and claims, by this reference.

### COPYRIGHT NOTICE

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to household cabinets and kitchen storage space structures, and more particularly, to island type kitchen counters.

### BACKGROUND

Kitchen counters, including counters utilizing an “island” design, in which a stand alone work counter is provided, have been utilized for many years. However, many currently utilized designs utilize a fixed island counter top and a plurality of cabinet spaces below the counter top, e.g., spaced about or within the periphery of the fixed island counter top. A few designs have the ability to provide electrical outlets or other utilities, such as a gas supply to a stove, or water to a sink. However, significant amounts of potential storage space are wasted due to the inability of such designs to practically access the interior portions of the space beneath such fixed island counter tops.

Since kitchen storage space in residential construction is increasingly scarce and/or increasingly costly in many locales (on a cost per square foot basis) there remains a need for a storage space design that can reliably provide the needed storage space while minimizing or eliminating the presence of unused space adjacent fixed island counter top structures.

### SUMMARY

I have now developed a storage structure design that enables utilization of space below fixed island counter tops, and more particularly, the utilization of previously underutilized space at or adjacent the interior of fixed island countertops structures. Such kitchen counter island countertop storage designs are provided as a moveable riser structure, where the height of the structure can be varied. In one embodiment, the storage structure is provided so that it is normally positioned in a closed, downward configuration, wherein the top of the island riser provides a countertop portion that matches, in close fitting engagement, the size, shape, and material of adjacent countertop areas. In such a design, the storage structure can be repositioned to an upward, accessible position, wherein the storage spaces in the structure reachable for retrieval from, storage to, or usage of, objects placeable on or in the structure.

In one embodiment, a kitchen counter island riser apparatus is provided for providing cabinet space that is moveable between a downward, stowed position wherein the cabinet provides a visible, upper, countertop portion, and an upward, accessible position wherein cabinet receiving portions are accessible for reaching, storing, and/or using goods placed in or on such receiving portions. The kitchen cabinet island riser apparatus includes a base configured to be supported by a lift mechanism that is mounted on a floor or other substrate, and a cabinet assembly coupled to the base for upward and downward movement with respect to the substrate. The drive mechanism may be electrically driven, and may include a gear train adapted for operatively driving the kitchen cabinet island riser in upward or downward movement. In such a fashion, the lift mechanism is collapsible for occupying a minimum amount of space when the kitchen counter island riser apparatus is in the downward, stowed position.

Sensors may be provided to protect the user or bystanders from pinch point impacts, and in one design, resistance to movement or sensing of objects in the way can be utilized to direct controls for the lift mechanism to stop and/or reverse movement, as suitable in the circumstances. In one embodiment, photoelectric beam sensors are provided adjacent to the pinch points between fixed counter top portions and the moveable cabinet portion. In such a design, photoelectric emitters and receivers may be utilized for monitoring and directing the action of the lift mechanism, and, for example, if fingers get in the way of the moving cabinet portion, the movement of the lift can be immediately reversed. The sensor devices may be operative to protect against injury, and operate in the fashion, for example, of automatic garage door reversing mechanisms, when resistance to movement is encountered.

In one embodiment, the kitchen counter island riser may further include utility connections, such as electrical or phone outlets, for use appliances at the kitchen counter island. For example, an electrical outlet may be utilized for providing electrical power to common kitchen appliances such as a mixer or a toaster. In such an embodiment, the utility lines or wires are easily provided in flexible lengths for movement with the lift mechanism.

The foregoing briefly describes a kitchen counter island riser apparatus having a lift mechanism for raising and lowering the counter, from a downward, a countertop forming position to an upward, cabinet using position, and vice versa. The kitchen counter island riser design can be provided in a variety of sizes and shapes complementary to available storage space that may be provided in a kitchen counter island design. The invention will be more readily understood upon consideration of the following detailed description, taken in conjunction with careful examination of the accompanying figures of the drawing.

### BRIEF DESCRIPTION OF DRAWING

In order to enable the reader to attain a more complete appreciation of the invention, and of the novel features and advantages thereof, attention is directed to the following detailed description when considered in connection with the accompanying drawings, wherein:

FIG. 1 provides a perspective view of a rectangular shaped kitchen counter island riser that is in a downward, stowed position, with the top of the kitchen counter island riser providing a moveable counter top portion that matches the adjacent fixed counter top portion.

FIG. 2 is a perspective view of the first embodiment just illustrated in FIG. 1 above, now shown with the kitchen counter island riser in the upward or pop-up position, showing cabinet storage spaces, as well as illustrating the use of a lift, as well as mounting flanges for guide shafts affixed at each corner of the riser.

FIG. 3 is a vertical cross-sectional view, illustrating the kitchen counter island riser in a downward, closed position, with the riser stowed in the inner island space, and having an upper surface substantially coplanar with adjacent stationary counter top portions, and also showing the lift apparatus in its downward, stowed position.

FIG. 4 is a vertical cross-sectional view, illustrating the kitchen counter island riser in an upward, working position, with the riser situated above the stationary counter top portions, and also showing the lift apparatus in its upward, extended position.

FIG. 5 is a partial vertical cross-sectional view, illustrating the kitchen counter island riser in an upward, working position, showing one embodiment for guide shaft, bearing, and bearing to riser mounting flange, for guiding the island riser upward and downward in a secure, moveable position.

FIG. 6 is a partially broken away perspective view, illustrating the upper and lower mounting flanges for securing in a working position the first and second feather shafting type guide shafts, as well as the bearing housings that secure the bottom of the island riser to the guide shafts.

FIG. 7 is a detailed perspective view of lower and upper mounting flanges that secure a guide shaft into a working position, and a bearing housing that is slidingly displaceable along the guide shaft, as well as a mounting flange attached to the bottom of the kitchen cabinet island riser for attachment of the bearing housing.

FIG. 8 is a further vertical cross-sectional view, depicting lower mounting flanges for support of a guide shaft, and a lift mechanism mounted beneath a kitchen cabinet island riser.

FIG. 9 is a horizontal plan view, taking looking down on the island riser cabinet apparatus first depicted in FIG. 8, now showing the position of four separate guide shafts and related mounting flanges and bearing housings.

FIG. 10 is an electrical schematic depicting the operation of control mechanisms for the kitchen cabinet island riser.

FIG. 11 is an end elevation view of one end of a kitchen cabinet island riser, showing the implementation of an electrical outlet in the end cabinet space of the island riser cabinet.

FIG. 12 is a perspective view of one embodiment for a kitchen cabinet island riser, showing the dimensions for one such embodiment, where various cabinet receiving portions are provided.

FIG. 13 is a side elevation view of one side of a kitchen cabinet island riser, showing the implementation of electrical outlets in several different side cabinet spaces of the island riser cabinet.

FIG. 14 is a perspective view of one embodiment for a kitchen cabinet island riser, showing shelves provided at one end, as well as a plurality of cabinet spaces along one side of the island riser cabinet.

FIG. 15 is a perspective view of one side of a finished and in-use kitchen cabinet island riser, showing the storage of various appliances, including a mixer and a toaster, in the cabinet spaces provided by the island riser cabinet.

FIG. 16 is a perspective view of a kitchen island in which a kitchen cabinet island riser is secured in a downward, stowed, hidden away position, leaving a substantially uniform and level top portion and stationary portion.

In the various figures of the drawing, like features may be illustrated with the same reference numerals, without further mention thereof. Further, the foregoing figures are merely exemplary, and may contain various elements that might be present or omitted from actual implementations of various embodiments depending upon the circumstances. An attempt has been made to draw the figures in a way that illustrates at least those elements that are significant for an understanding of the various embodiments and aspects of the invention. However, various other elements of a kitchen counter island riser system with lift apparatus and utility hookups, especially as may be developed using different variations of the functional components illustrated, as well as different embodiments such as a shape of components or final design of various elements, may be utilized in order to provide a useful, reliable, kitchen counter island riser apparatus utilizing a pop-up design useful for minimizing lost space and for providing storage cabinet space for equipment and objects in the kitchen.

### DETAILED DESCRIPTION

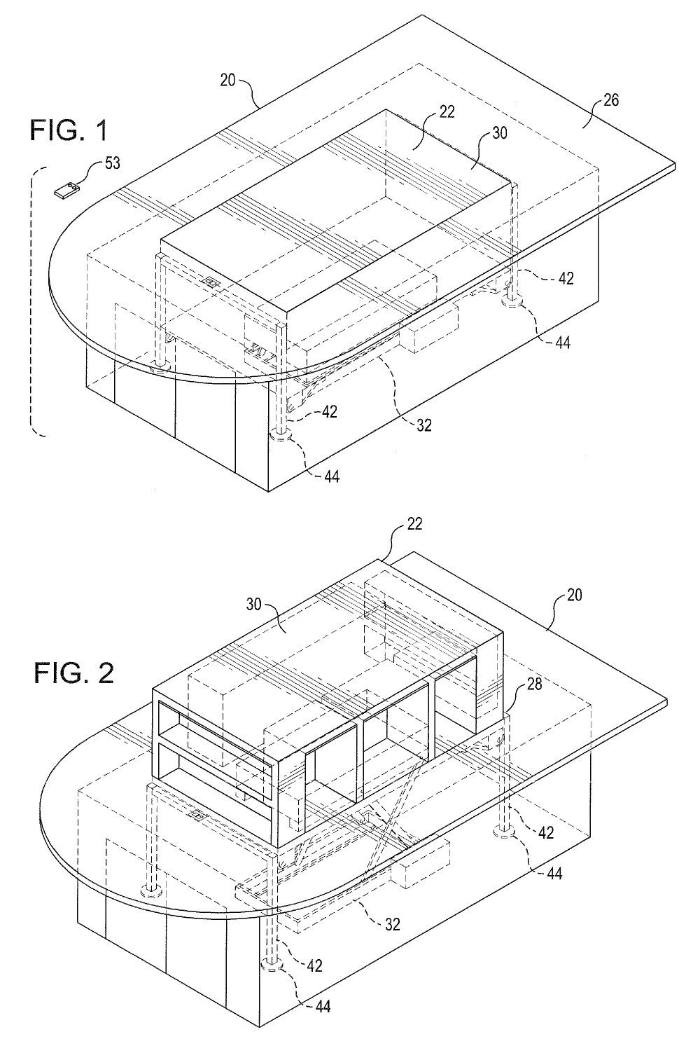

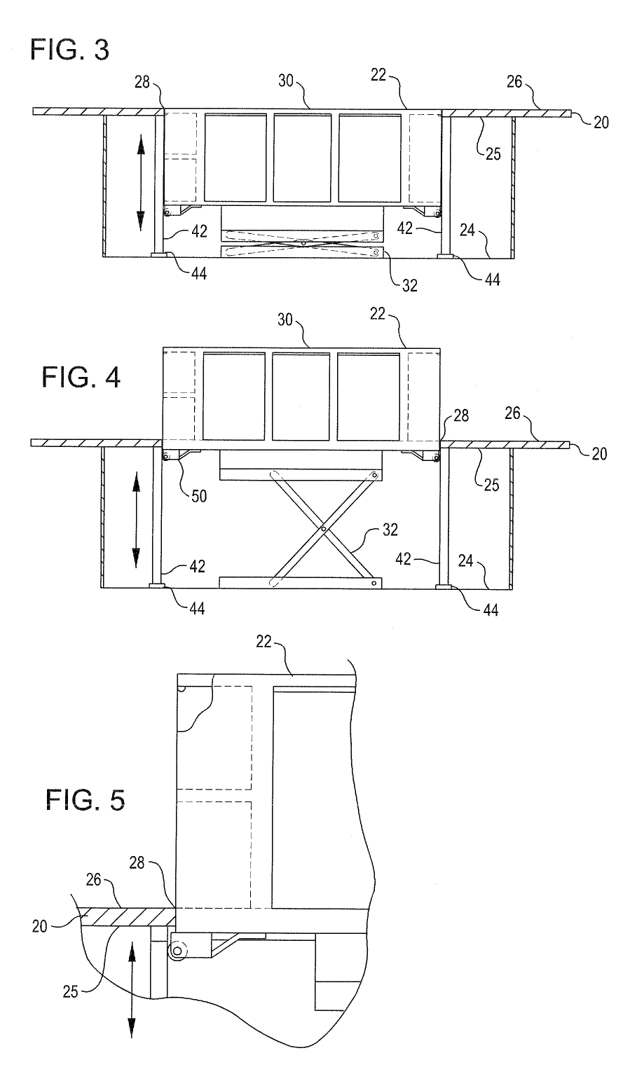

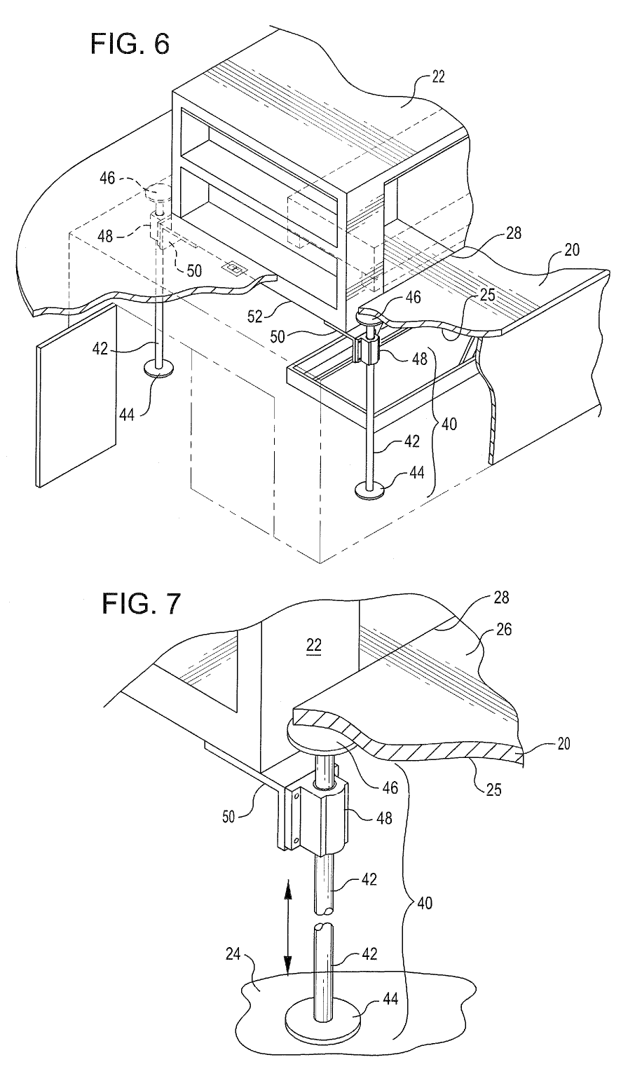

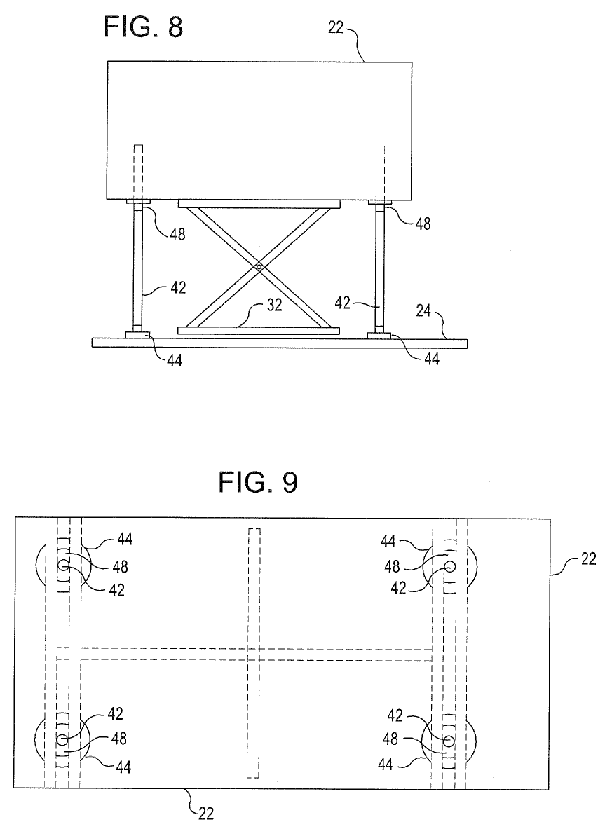

Attention is directed to FIG. 1 of the drawing, which provides a perspective view of an exemplary stationary kitchen island counter 20 with moveable cabinet riser 22. As can be seen in FIGS. 3, 4, and 16, the stationary kitchen counter 20 may be mounted above a substrate 24 such as a kitchen floor. The stationary kitchen counter 20 has a lower portion 25, and an upper surface 26 which surface may be a suitable kitchen surface material such as polished granite. The upper surface 26 has a cut-out portion defined by cut-out edge wall portions 28. The moveable cabinet riser 22 has a riser counter top surface 30, at least partially complementary in size and shape to the cut-out edge wall portions 28 of the stationary kitchen counter 20. The riser counter top surface 30 is normally also provided in a suitable kitchen surface material such as polished granite. In one embodiment, the upper surface 26 and the counter to surface 30 may be made of the same material.

A lift assembly 32 is provided. The lift assembly 32 is disposed between the substrate 24 and the moveable cabinet riser 22. The lift assembly 32 is operable to move the moveable cabinet riser 22 between (1) a downward, stowed position wherein the riser counter top surface 30 and the upper surface 26 of the stationary island counter 20 are substantially coplanar, and (2) an upward, working position, wherein the movable cabinet riser 22 is situated substantially above the upper surface 26 if of the stationary kitchen island counter 20.

One or more guide shaft assemblies 40 are provided. Each of the one or more guide shaft assemblies 40 include a guide shaft 42, a lower mounting flange mount 44, an upper mounting flange mount 46, and a bearing housing 48. The guide bearing housing 48 is attached to the moveable cabinet riser 22, which attachment in one embodiment is accomplished by use of a mounting flange or bracket 50 affixed to the moveable cabinet riser 22, which in an embodiment may be at the lower side 52 of moveable cabinet riser 22. The guide bearing housing 48 has therein a guide bearing 54 therein complementary to the guide shaft 42. The guide bearing housing 48 mounted on the guide shaft 42 for sliding linear engagement of the guide bearing 54 with the guide shaft 42. In an embodiment, the guide shafts 42 may be vertically mounted above the substrate 24. In one embodiment, the guide shafts 42 are mounted between the substrate 24 and lower portion 25 of the stationary counter 20. In one embodiment, the moveable cabinet riser 22 is provided in a generally rectangular or parallelepiped shape, and thus, has four corners, and in such an embodiment, a guide shaft assembly 40 is provided at each of the four corners.

In one embodiment, the guide shafts 42 are provided as solid aluminum shafts. Such shafts may be provided with a ceramic coated finish. In one embodiment, the lower flange mounts 44 are provided as self-aligning mounting flanges. Similarly, in an embodiment, the upper mounting flange mounts 46 may be provided as self-aligning mounting flanges.

In one embodiment, the kitchen counter island riser design is provided in a configuration such that when the moveable cabinet riser 22 is in a downward, stowed position as shown in FIGS. 1 and 3, the upper surface 26 and the riser counter top surface 30 together form a substantially smooth, continuous, multi-part counter surface.

In one embodiment, the lift assembly 32 can be provided as an electric lift. One suitable lift has been found to be a double scissors type lift available from Selby Furniture Hardware Company Inc. in New York, USA.

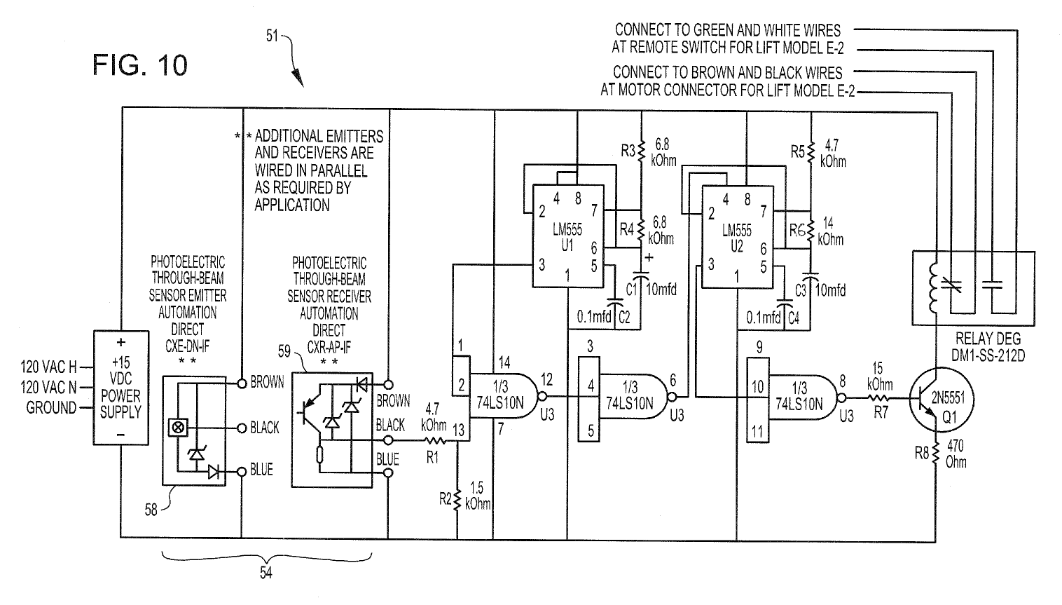

In one embodiment, an electronic control system 51 can be provided for the lift assembly 32. As noted in FIG. 1, the electronic control system 51 may include a remote control unit 53 for actuation of the lift assembly 32. As illustrated in FIG. 10, a safety interlock system 54 may be provided. The safety interlock system 54 may include a photoelectric through beam sensor emitter 58 and a sensor receiver 59 for transmitting and receiving a sensing signal 61. The through beam sensor receiver 59 is operable to reverse operation of lift assembly 32 when the through beam sensor detects interruption of an emitted sensing signal.

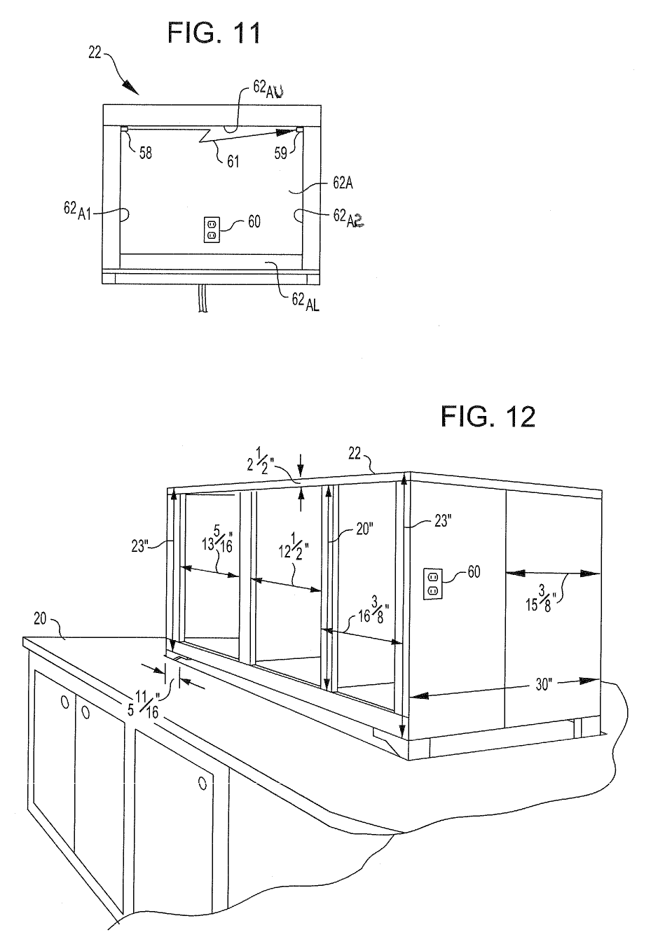

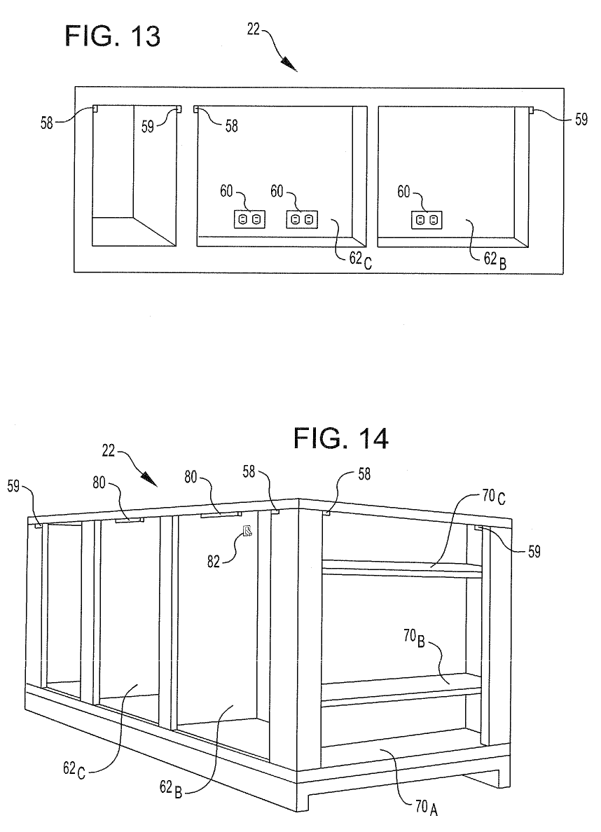

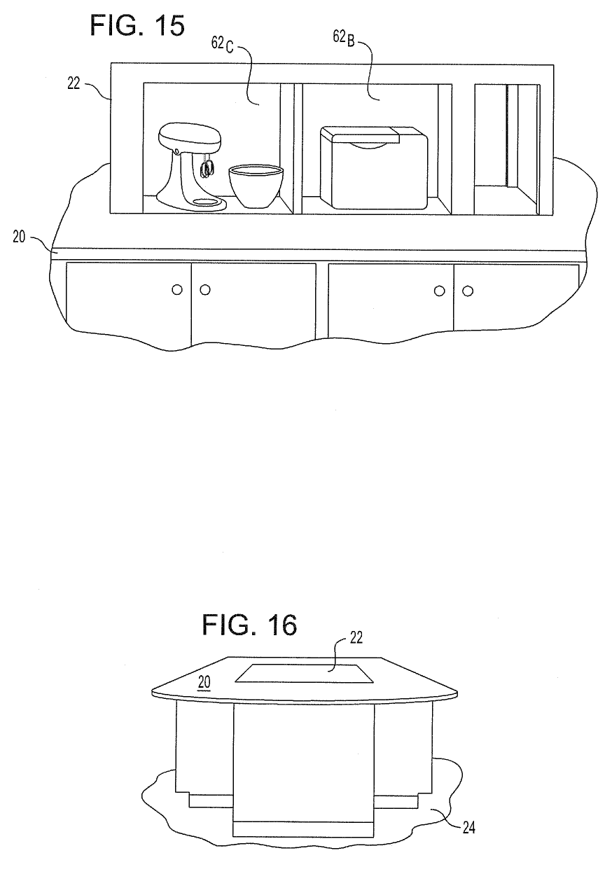

As illustrated in FIGS. 11 and 13, the moveable cabinet riser 22 may further include one or more electrical outlets 60. Further, the moveable island riser may include a plurality of cabinet receiving spaces 62_{A}, 62_{B}, 62_{C}, etc, normally defined by lower (e.g., 62_{AL}), and upper (e.g., ⁶²_{AU}) walls and interior sidewalls (e.g., 62_{A1} and 62_{A2}).

As noted in FIG. 14, the movable cabinet riser 22 may also include a plurality of shelves 70_{A}, 70_{B}, 70_{C}, etc, as well as lights 80, for example, a halogen light, which may be adjustably controlled via suitable device such as rheostat 82. Finally, the moveable cabinet riser 22 may be adjusted to suitable height via suitable adjustable limit switches. Further, a moveable cabinet riser 22 assembly may be fabricated off-site and shipped in a single container for remote installation. In some applications, it may also be useful to provide a steel frame adjacent to the moveable cabinet riser 22 for support of the stationary countertop 20.

It is to be appreciated that the various aspects, features, structures, and embodiments of a kitchen counter island riser, with uniform top surface matching a stationary island counter top, as described herein is a significant improvement in the state of the art. The kitchen counter island riser system is simple, reliable, and easy to use. Although only a few exemplary aspects and embodiments have been described in detail, various details are sufficiently set forth in the drawing figures and in the specification provided herein to enable one of ordinary skill in the art to make and use the invention(s), which need not be further described by additional writing.

Importantly, the aspects, features, structures, and embodiments described and claimed herein may be modified from those shown without materially departing from the novel teachings and advantages provided, and may be embodied in other specific forms without departing from the spirit or essential characteristics thereof. Therefore, the various aspects and embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings. The scope of the invention, as described herein is thus intended to include variations from the various aspects and embodiments provided which are nevertheless described by the broad meaning and range properly afforded to the language herein, as explained by and in light of the terms included herein, or the legal equivalents thereof.

1. An article of manufacture, comprising:
(a) a stationary counter, said stationary counter mounted above a substrate, said stationary counter comprising an upper surface, said upper surface having a cut-out portion defined by cut-out edge wall portions;
(b) a moveable cabinet riser, said moveable cabinet riser comprising a frame and a riser counter top, said riser counter top having a perimeter at least partially complementary in size and shape to said cut-out edge wall portions of said stationary counter;
(c) a lift assembly, said lift assembly disposed between said substrate and said moveable cabinet riser, said lift assembly operable to move said moveable cabinet riser between (1) a downward, stowed position wherein said riser counter top and said upper surface of said stationary counter are substantially coplanar, and (2) an upward, working position, wherein said movable cabinet riser is situated substantially above said upper surface of said stationary counter.

2. The apparatus as set forth in claim 1, further comprising one or more guide shaft assemblies, each of said one or more guide shaft assemblies comprising a guide shaft, a lower mounting flange mount, an upper mounting flange mount, and a bearing housing attached to said moveable cabinet riser, said bearing housing having a guide bearing therein complementary to said guide shaft, said guide bearing housing mounted on said guide shaft for sliding linear engagement of said guide bearing with said guide shaft.

3. The apparatus as set forth in claim 2, wherein each of said guide shafts is vertically mounted above said substrate.

4. The apparatus as set forth in claim 3, wherein said stationary counter further comprises a lower side, and wherein each guide shaft is mounted between said substrate and lower side of said stationary counter.

5. The apparatus as set forth in claim 4, wherein four guide shaft assemblies are provided.

6. The apparatus as set forth in claim 5, wherein said moveable cabinet riser is provided in a rectangular shape having four corners.

7. The apparatus as set forth in claim 6, wherein a guide shaft assembly is provided at each of said four corners of said movable cabinet riser.

8. The apparatus as set forth in claim 1, wherein when said moveable cabinet riser is in said downward, stowed position, said upper surface and said riser counter top form a substantially smooth, continuous, multi-part counter surface.

9. The apparatus as set forth in claim 2, wherein said guide shafts comprise solid aluminum shafts.

10. The apparatus as set forth in claim 9, wherein said guide shafts further comprise a ceramic coated finish.

11. The apparatus as set forth in claim 2, wherein said lower flange mounts comprise self-aligning mounting flanges.

12. The apparatus as set forth in claim 2, wherein said upper flange mounts comprise self-aligning mounting flanges.

13. The apparatus as set forth in claim 1, wherein said lift assembly comprises an electric lift.

14. The apparatus as set forth in claim 1, wherein said lift assembly comprises a scissors lift configuration.

15. The apparatus as set forth in claim 1, further comprising an electronic control system for said lift assembly.

16. The apparatus as set forth in claim 15, wherein said electronic control system further comprises a remote control unit for actuation of said lift assembly.

17. The apparatus as set forth in said claim 15, further comprising a safety interlock system.

18. The apparatus as set forth in claim 17, wherein said safety interlock system comprises a photoelectric through beam sensor having an emitter and a receiver for transmitting and receiving a sensing signal, said through beam sensor operable to reverse operation when said through beam sensor detects interruption of said sensing signal.

19. The apparatus as set forth in claim 1, wherein said moveable island riser further comprises one or more electrical outlets.

20. The apparatus as set forth in claim 1, wherein said riser counter top comprises polished granite.

21. The apparatus as set forth in claim 20, wherein said upper surface of said stationary counter top comprises polished granite.

22. The apparatus as set forth in claim 1, wherein said moveable island riser comprises a plurality of cabinet receiving spaces.

23. The apparatus as set forth in claim 22, wherein a plurality of electrical outlets are provided in at least one of said plurality of cabinet receiving spaces.

24. The apparatus as set forth in claim 1, wherein said moveable island riser comprises a plurality of shelves.

25. An article of manufacture, comprising:
(a) a stationary counter, said stationary counter mounted above a substrate, said stationary counter comprising a lower side and an upper surface, said upper surface having a cut-out portion defined by cut-out edge wall portions;
(b) a moveable cabinet riser, said moveable cabinet riser comprising a frame and a riser counter top, said riser counter top having a perimeter at least partially complementary in size and shape to said cut-out edge wall portions of said stationary counter, said moveable cabinet riser generally parallelepiped in shape and having four corners
(c) a lift assembly, said lift assembly disposed between said substrate and said moveable cabinet riser, said lift assembly operable to move said moveable cabinet riser between (1) a downward, stowed position wherein said riser counter top and said upper surface of said stationary counter are substantially coplanar, and (2) an upward, working position, wherein said movable cabinet riser is situated substantially above said upper surface of said stationary counter;
(d) four guide shaft assemblies, of said four guide shaft assemblies mounted adjacent each one of said four corners of said movable island riser, each of said guide shaft assemblies comprising a vertically mounted guide shaft, a lower mounting flange mount, an upper mounting flange mount, each of said guide shafts mounted between said substrate and said lower side of said stationary counter, and a bearing housing attached to said moveable cabinet riser, said bearing housing having a guide bearing therein complementary to said guide shaft, said guide bearing housing mounted on said guide shaft for sliding linear engagement of said guide bearing with said guide shaft;
(e) wherein when said moveable cabinet riser is in said downward, stowed position, said upper surface and said riser counter top form a substantially smooth, continuous, multi-part counter surface.
